(19) United States
(12) Patent Application Publication
(10) Pub. No.: US 2006/0093054 A1
(43) Pub. Date: May 4, 2006

(54) Method and apparatus for signal coding

(76) Inventors: Igor S. Djokovic, Costa Mesa, CA (US); Richard D. Wesel, Manhattan Beach, CA (US)

Correspondence Address: WEIDE & MILLER, LTD., 7251 W. LAKE MEAD BLVD., SUITE 530, LAS VEGAS, NV, 89128, US

(21) Appl. No.: 11/244,483

(22) Filed: Oct. 5, 2005

Related U.S. Application Data
(60) Provisional application No. 60/616,046, filed on Oct. 5, 2004.
(60) Provisional application No. 60/616,045, filed on Oct. 5, 2004.

(51) Int. Cl. H04L 23/02

(52) U.S. Cl. 375/265

(57) ABSTRACT

A method and apparatus is disclosed for use in a communication system for encoding data to achieve more efficient coding rates and high data transmit rate, or a lower bit error rate. An encoder may receive a portion of the data to be encoded and process the portion of the data to create encoded data. The encoded data and the portion of the data not sent to the encoder are presented to a transform module configured to perform matrix multiplication on the inputs with a transform matrix. The resulting transformed data is mapped, using a mapper, either via an algorithmic approach or a manual mapping approach to generating a constellation mapped output. 2-dimensional encoding may occur.

### PRIORITY CLAIM

This patent application claims priority to U.S. Provisional Patent Application serial No. 60/616,046 entitled Method and Apparatus for Signal Coding, filed Oct. 5, 2004, and U.S. Provisional Patent Application serial No. 60/616,045 entitled Trellis Constellation Shaping, filed Oct. 5, 2004.

### FIELD OF THE INVENTION

The invention relates to communication systems, and in particular to an improved method and apparatus for signal coding.

### RELATED ART

Modern communication systems exchange data between remote locations using complex coding schemes to minimize the bit error rate and maximize the signal to noise ratio. As a result, the data throughput may be maximized. As one coding approach to increase the effective data rate, trellis coded modulation may be adopted.

The basic principles of trellis coded modulation (TCM) are generally understood and, as such, an exhaustive discussion of TCM is not provided beyond the following discussion. TCM is a way of achieving a lower bit error rate (BER) for a given SNR at the expense of increased constellation size. In many common applications, for each symbol (2D, 4D, etc. depending on the dimensionality of the code), there is one extra bit (redundancy). So in general these types of TCM codes have rate n/(n+1). For simplicity reasons, when constellations are big, bits are partitioned into n_{c} coded and nᵤ uncoded bits (n=n_{c}+nᵤ).

As can be appreciated, there is a demand for communication systems to achieve higher effective data rates. The method and apparatus described below departs from the standard teaching in the art by utilizing a new path of development to increase coding gain, which in turn increases the potential effective data transmission rate.

A method and apparatus is disclosed for use in a communication system for encoding data to achieve more efficient coding rates and high data transmit rate, or a lower bit error rate. An encoder may receive a portion of the data to be encoded and process the portion of the data to create encoded data. The encoded data and the portion of the data not sent to the encoder are presented to a transform module configured to perform matrix multiplication on the inputs with a transform matrix. The resulting transformed data is mapped, using a mapper, either via an algorithmic approach or a manual mapping approach to generating a constellation mapped output. 2-dimensional encoding may occur.

In one embodiment a convolutional coder of rate n_{c}/(n_{c}+1) is used to select one of 2⁽ⁿ⁺¹⁾_{c} cosets from which to encode the bits, being transmitted. The coset is defined as a sub-set of points selected from all the points in the constellation. To determine which point in the coset to utilize, the nᵤ bits are analyzed to select one of 2⁽ⁿ⁺¹⁾ᵤ points in the chosen coset. By partitioning the whole set in this way, intra-coset minimum distance is increased by 3(n_{c}+1) dB for two-dimensional codes. Stated another way, the distance between points for a particular coset is increased thereby reducing the likelihood that, after transmission and during de-coding, an incorrect decoding decision will be made.

To reflect the increase in the number of bits that are transmitted due to the TCM, a penalty for increased power is subtracted from the coding gain. The penalty is about 3 dB for a two-dimensional code, so the upper bound on achievable coding gain is 3n_{c}dB. Thus, it can be observed that with n_{c}=1 (i.e. rate ½) 2D codes we can achieve 3 dB of coding gain.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a block diagram of a prior art encoding and mapping system.

FIG. 2 illustrates a block diagram of an example embodiment of an exemplary encoding and mapping system.

FIG. 3 illustrates a block diagram of an example embodiment of an encoder utilizing an improved TCM code.

FIG. 4 illustrates a matrix representation of the operations needed to terminate the TCM code.

FIG. 5 illustrates a mathematical example representation of one example transform module. iS

FIG. 6A illustrates an example embodiment of a trasform module.

FIG. 6B illustrates an example embodiment of a transform module.

FIG. 7 illustrates an exemplary coset structure.

FIG. 8 illustrates an exemplary 8-point constellation for b=3.

FIG. 9 illustrates an operational flow diagram of an example method of operation.

FIG. 10 illustrates bit error rate (BER) curves for uncoded and coded DMT systems with uniform bit loadings of b=2, 3 . . . 17 bits per 2D symbol.

FIG. 11 illustrates plots of 2D codes for inverse functions (SNR as a function of BER) being subtracted from uncoded systems with corresponding rates.

FIG. 12 illustrates average coding gain curves with the Wei code on the bottom plot followed by plots for 64, 128, and 256 states respectively to the top.

FIG. 13A-13C illustrates average coding gain curves for three codes.

FIG. 14 illustrates a portion of a large constellation with cosets labeled, and the received point shown as the intersection of the distance lines labeled D₀ through D₇.

### DETAILED DESCRIPTION

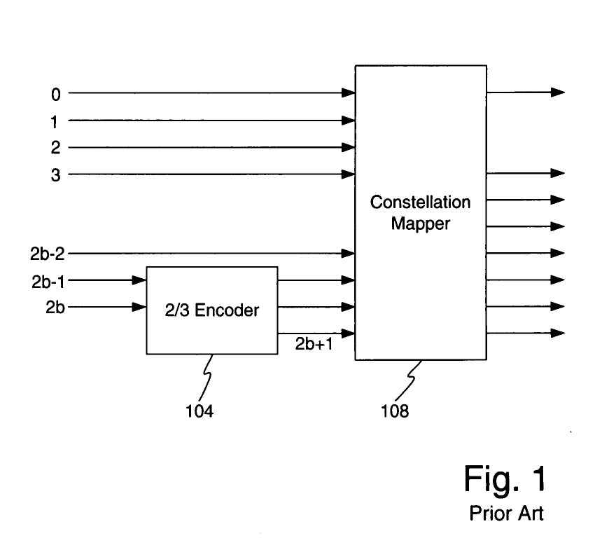

FIG. 1 illustrates a prior art trellis code modulation (TCM) encoder. In this embodiment, a 2/3 encoder 104 is utilized in connection with a mapper 108. Inputs to the system are labeled 0 through 2b inputs, each of which may carry a bit of data. The inputs 2b and 2b-1 are provided to the encoder 104 while the remaining inputs 0 through 2b-2 are provided directly to the mapper 108, which may comprise a constellation mapper. The output of the encoder 104 comprises three outputs such that the actual number of inputs to the mapper is 2b+1. As part of the TCM process, the encoder output serves as a coset selector such that the value of the encoder output determines within which of the two or more cosets to map the data points, namely the data on inputs 0 through 2b-2, during the constellation mapping process.

The structure of the encoder is determined by a code, upon which the encoder is configured. The prior art code is referred to as the Wei code, after the individual who discovered this code. The code may be represented as an equation, such as a polynomial with binary coefficients, which is implemented in hardware, such as for example, by the encoder.

The Wei code is widely used in several applications and is adopted as the industry standard in the ADSL ITU recommendation for high speed wireline communications. It is generally believed to be a highly desirable and optimal code. Although the most popular and the industry standard for TCM encoding, the inventors listed above discovered that other codes yield better effective data rates. As a result, one novel feature of the method and apparatus disclosed herein is the use of other codes in a TCM system to improve the effective data rate. Thus, after discovering other codes for use with TCM coding, it was revealed that the Wei codes suffer from the drawback of limiting the potential effective data rate.

Using the new codes disclosed herein and by setting n_{c}=1 (i.e. rate ½) and for 2D codes, it is possible to achieve 3 dB of coding gain. In one embodiment, to achieve a coding gain better than that associated with the Wei code (4.2 dB), a 2/3 or higher code is utilized.

Using Ungerboeck's set partitioning labeling, the constellation is divided into a sum of cosets. QAM type modulation may be utilized.

As discussed above, the encoded bits are utilized to select a particular coset, i.e. predefined subset of points in the constellation. The uncoded bits are mapped into the points within a particular coset, during the constellation mapping process. Although prior art codes may be utilized in the system of FIG. 1, the teaching of the prior art discourages such use because the mapping of uncoded bits into the points of the coset is complex, cumbersome, and may not yield the desired coding gain. In one embodiment, it is possible to map uncoded bits using basis vectors from each coset representative. However, in the case of an odd number of uncoded bits, it produces rectangular constellations, which may need to be mapped using modulo operations or a cumbersome look-up table to some equivalent square. This may be an undesirably complex, time consuming and resource intensive operation.

In one example embodiment, the undesirably complex, time consuming and resource intensive constellation mapping operation is simplified through the use of a label transformation module or bit-label transform operation. The term label is used because the data processed by the transformation module identifies, or labels, the coset and constellation point within the coset.

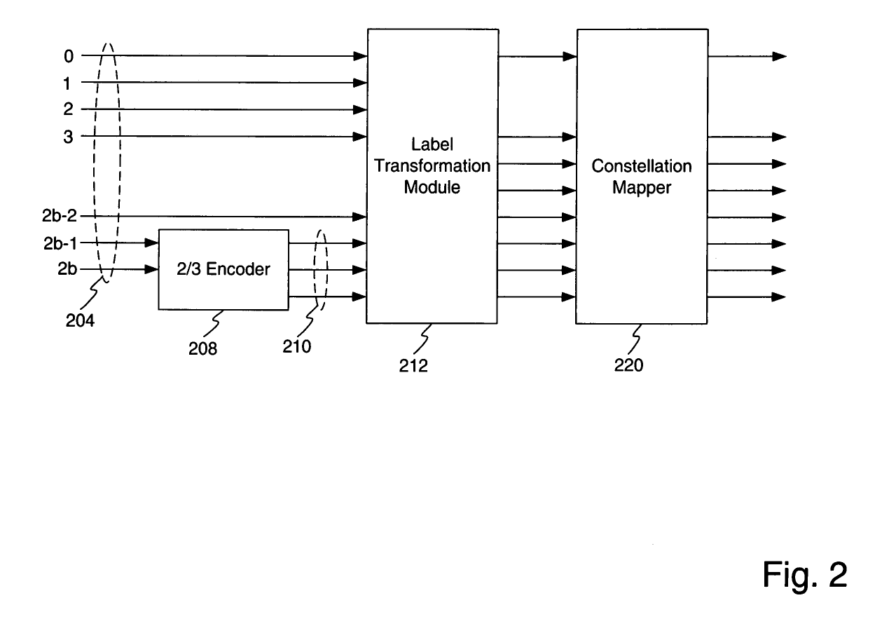

FIG. 2 illustrates a block diagram of an example embodiment of a TCM encoder 208 with label transformation module 212. This is but one example embodiment and, as such, it is contemplated that in other embodiments other arrangements or configurations may be reached without departing from the scope of the invention. The inputs 204, including the output 210 of the encoder 208, feed into a label transformation module 212. The transform module 212 may comprise hardware, software, or a combination of both configured to modify its inputs to a format suitable for constellation mapping. In one embodiment, the label transformation module 212 may also optimize the spacing between coset points to increase coding gain. In one embodiment, the label transformation module 212 comprises a combinatorial circuit. It is contemplated that the label transformation module 212 and the method described herein may be used with an even or odd number of inputs, i.e. bits, although it may be necessary to utilize a larger square constellation and choose a coset, which will have a square shape.

The output of the label transformation module 212 connects to a constellation mapper 220. The various components shown in FIG. 2 are now described in more detail.

Encoder Structure

With regard to the structure of the encoder, it may be created based on any code that improves the coding gain. Convolutional codes can be represented/implemented implemented in feedforward and feedback form. Even though they do not produce identical sequences, their performances may be the same. Namely, every feedback code representation has its equivalent feedforward code representation. In one embodiment, a feedback representation is utilized and the code is defmed as {115, 52, 36} in octal representation. These three numbers correspond to three generator polynomials.

The binary representation of these numbers may be written as follows:

(115)ₒ=1001101

(52)ₒ=0101010

(36)ₒ=0011110

The LSB of each of these numbers denotes the contribution of each current input bit to the current output bit. Other binary digits indicate if that input (output in the case of the first polynomial) is connected to the input of a particular delay element or not.

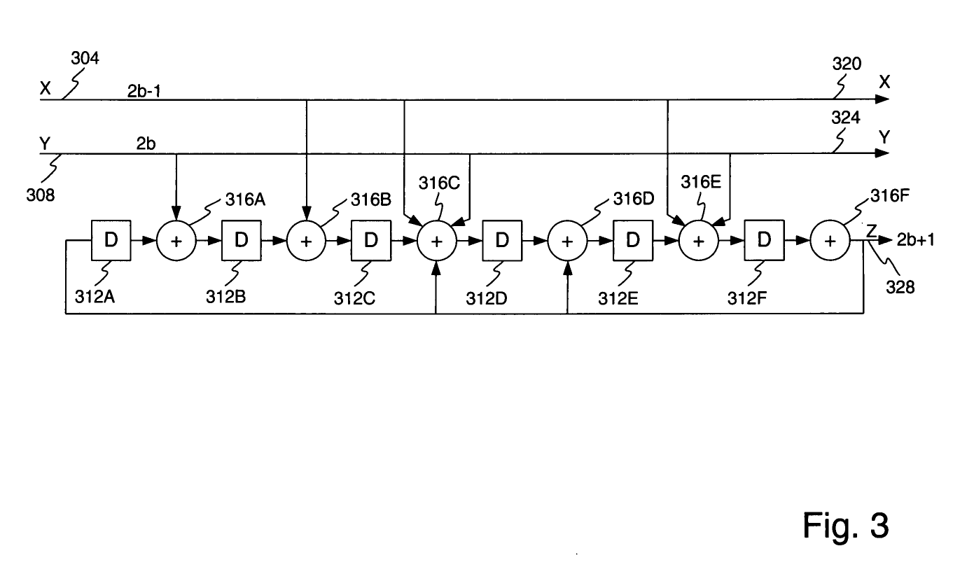

A discussion of the structure utilized to represent these polynomials is now provided. FIG. 3 illustrates an example embodiment of the encoder utilizing one exemplary code. This encoder provides superior coding gain if its output is mapped to a 2-dimensional constellation. It therefore belongs to the class of 2-dimesional codes, in contrast to the Wei code that belongs to the class of 4-dimensional codes. Further, the class of new codes may also be selected from the group of codes comprising any 2/3 convolutional code that realize a coding gain over the Wei code. It is further contemplated that the label transformation module may be configured to work with any two dimensional, n/k code where k is odd.

In this example embodiment of a 2/3 encoder, inputs 304 and 308 connect to one or more of the delay elements 312A-312F and summing junctions 316A-316F. The delay elements 312 may comprise any manner of delay as would be understood by one of ordinary skill in the art. The summing junctions 316 may comprise any device capable of combining two or more signals. The structure shown generates outputs signals on outputs 320, 324, and 328. Outputs 320 and 324 represent the input signal, while the signal on output 328 is generated by the encoder. The encoder may be enabled in hardware, software, or a combination of both. For example, the delays and summing junctions may be enabled using software code running on a processor.

In operation, the two input bits are processed by the encoder to generate three output bits. This example embodiment is a feedback implementation, so the output is fed back to delay elements to create the value on output 328. For this code implementation there are six delay elements due to the largest polynomial having degree 6.

This may also be referenced as a systematic encoder, where bits that are being encoded (x and y) are output unchanged. One extra bit of redundancy is added and this bit contains information about the history of previous inputs and outputs. All additions may be performed as mod 2, i.e. exclusive “OR”.

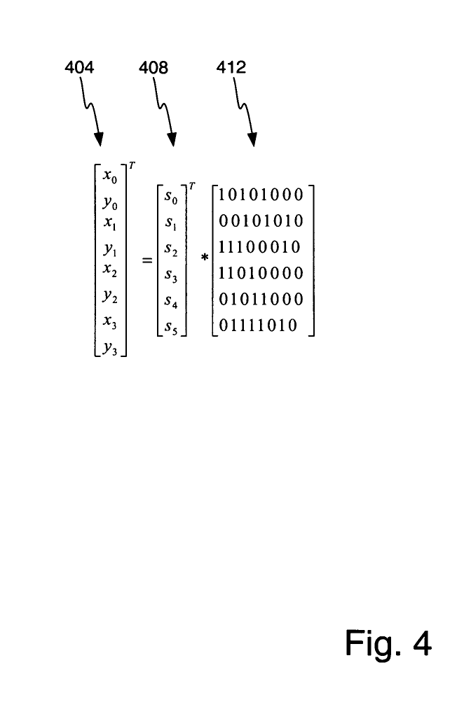

In order to avoid extra delay due to tracing back inside a Viterbi decoder across DMT symbol boundaries, it may be desired to terminate the trellis at the end of each block. Stated another way, it may be necessary to drive the encoder state to a predetermined value to flush the encoder of relevant data. Any value may be used, but in this embodiment “0” is used for the final state. By doing this, at the end of each DMT symbol, Viterbi decoder will be able to make decisions on all the states that belong to the path that ends in the zero state. This will result in an overhead (several last bits may have to be deterministic). In the particular case of code {115, 52, 36}, we can terminate the trellis (i.e. drive the state to zero) from any given state S in 4 steps. FIG. 4 illustrates a matrix representation of the operations needed to terminate the TCM code. In this example matrix, matrix S is shown as matrix 408, the x and y value matrix comprises matrix 404, and the termination matrix is matrix 412. Assume that S=(s₅, s₄, . . . s₀), then 4 input bits x and y can be computed as shown in FIG. 4, or in other words, y=s₂+3s₃+3s₄+3s₅ and x=7s₀+14s₁+11s₂+s₃+4s₄+14s₅. Notice that x₀ and y₀ correspond to LSBs, i.e. x=x₃x₂x₁x₀ and y=y₃y₂y₁y₀. Termination bits are fed starting with LSB. It can be noticed that in this example embodiment there are 8 bits, for 4 steps.

Transform Module

The label transformation module 212 (FIG. 2) modifies or manipulates the bits received on the inputs and the encoder output to a format suitable for use by the constellation mapper 220. Although the constellation mapper 220 may be configured to operate without the label transformation module 212, in one or more embodiments, the transformation module may be optionally utilized to adapt the input to the constellation mapper 220 (FIG. 2) to provide a constellation mapping that improves efficiency, reduces complexity and may improve coding gain.

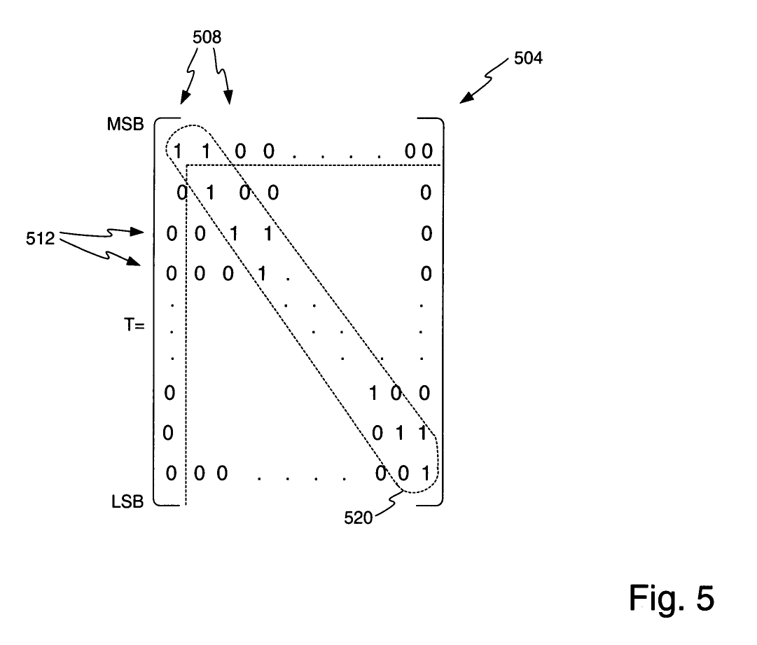

FIG. 5 illustrates a mathematical example matrix representation of one example label transformation module. In this representation, the transform module is represented as a matrix 504. The matrix 504 is characterized by one or more rows 512 and one or more columns 508. In this exemplary mathematical representation of the transform module, the matrix comprises a main diagonal of one values and alternating one and zero values in the off-diagonal as shown in 520. The remainder of the matrix is filled with zeros as shown. This matrix operates on the totality of the input labeling bits (including coded and uncoded bits) arranged as a row vector and produces the output labeling bits in a row vector. Other embodiments may utilize other matrix structures.

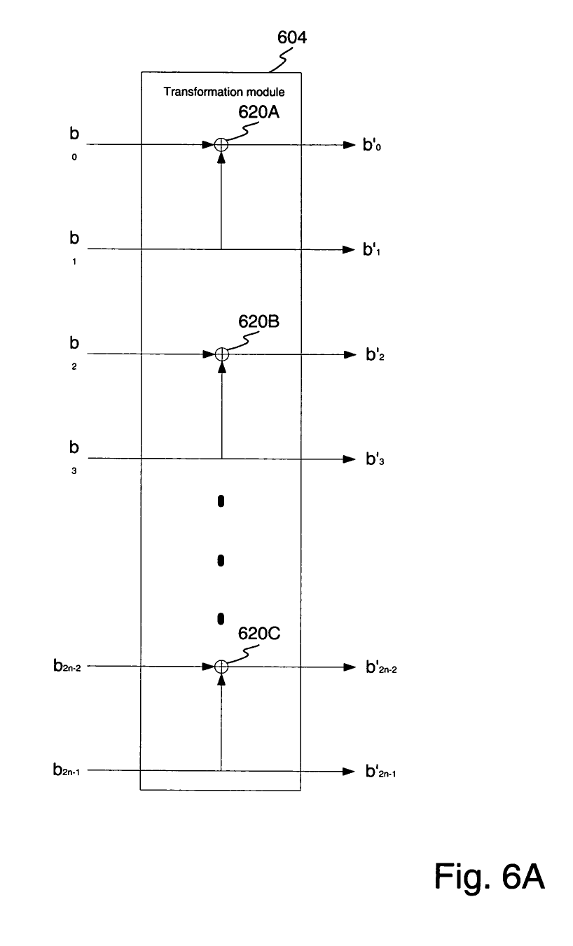

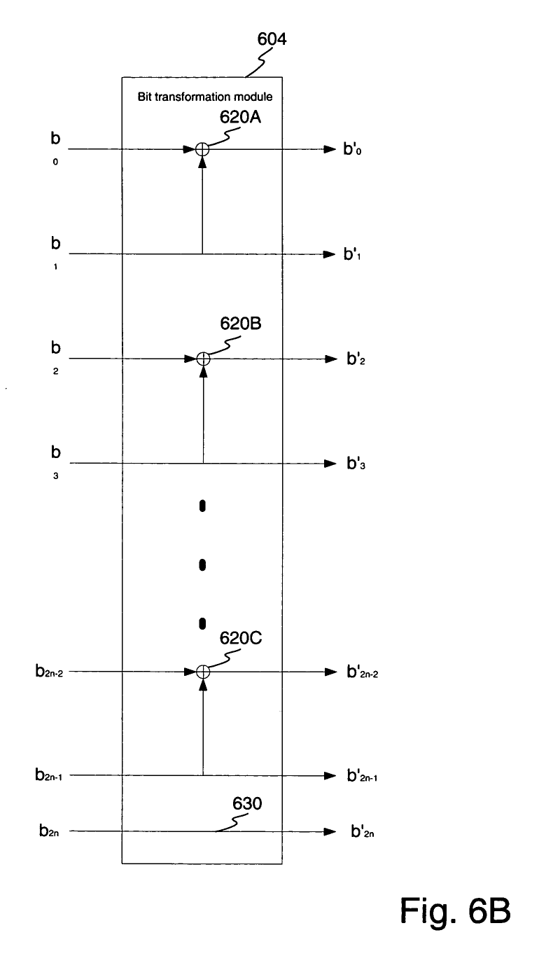

FIGS. 6A and 6B illustrate example embodiments of label transformation module. These example embodiments are provided to aid in understanding of one example embodiment and, as such, the invention should not be interpreted as being limited to these structures. As with the other elements, the label transformation module may be enabled in hardware, software, or a combination of both.

In the example embodiment of FIG. 6A, the module 604 is configured with inputs b₀ through b₂ₙ₋₁ and outputs b′₀ through b′₂ₙ₋₁. The inputs b₀ and b₁ connect to a summing junction 620. The output b′₀ comprises the logical XOR of these inputs while output b′₁ comprises the value b₁. The pattern of internal connections repeat as shown up to and including inputs b₂ₙ₋₂ and b₂ₙ₋₁.

In operation, the inputs undergo an XOR process with the adjacent input to create the transformed output as shown. The result of this process comprises an output that produces properly labeled coset points at the output of the constellation encoder.

FIG. 6B illustrates a block diagram of another example embodiment of the label transformation module 604. In relation to FIG. 6A, identical elements are labeled with identical reference numbers. The difference between the embodiments shown in FIGS. 6A and 6B account for an even or an odd number of input bits to the label transformation module. In contrast to the configuration shown in FIG. 6B, the input b₂ₙ passes directly to output b′₂ₙ as shown by connection 630.

Constellation Mapper/Demapper

As described above in general, after information bits are passed through the encoder and the label transformation module at the transmitter, they may be mapped in some way to a constellation point. This means that for a constellation that supports n bits, we need to label 2ⁿ points. This should not be done in an arbitrary way.

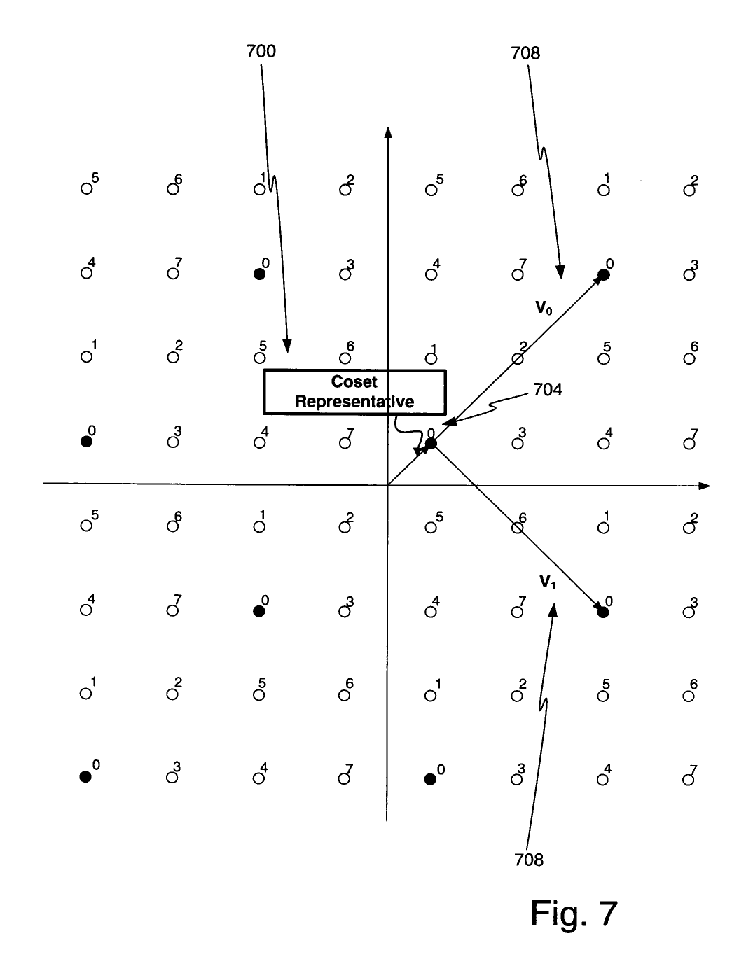

FIG. 7 illustrates an exemplary coset structure 700 with vectors 708. Firstly, in this example embodiment, it may be important to preserve the coset structure as shown in FIG. 7. Secondly, in this example embodiment, the system is able to support a wide range of constellations, e.g., from 3 to 17 bits per bin or even more, and, as such, this mapping (of both coded and uncoded bits) is to be done in an algorithmic way. The alternative, namely the use of look-up tables would be impractical, slow, and inefficient.

It is contemplated that more than one method may be utilized to perform the constellation mapping in an algorithmic manner. One configuration uses coset representatives 704 together with the two vectors v₀ and v₁ to reach any given point within the chosen coset (see FIG. 7). However, this approach may require modulo operations at the transmitter to have an optimal constellation shape (square or cross). An alternative approach is to map bits in a predetermined manner and then use a predefined mapping process, such as, for example, the mapping scheme specified in the ADSL standard. The DSL mapping scheme is well known in the art and, as such, is not described in detail herein. This manner of mapping has the desirable characteristic in that it preserves the coset membership of constellation points. An example embodiment based on this configuration is shown in FIG. 2 when the mapper 220 is configured based on the DSL standard mapping scheme.

The label transformation module may be represented as a matrix (See FIG. 5) and may be utilized in its inverse form at the receiver during the decoding process. This transmitter label transformation matrix may be described as follows. Starting from the LSB, even numbered bits are exclusive OR of the corresponding input bit and one bit higher. Odd numbered bits are the same as input bits. Stated another way, if the input bits are set as b₂ₙ₋₁, b₂ₙ₋₂, . . . b₁, b₀, then the output bits will be:

b′₀=b₀ xor b₁,

b′₁=b₁,

b′₂=b₂ xor b₃, . . .

b′₂ₙ₋₂=b₂ₙ₋₂ xor b₂ₙ₋₁

b′₂ₙ₋₁=b₂ₙ₋₁.

These properties hold even when an odd number of bits per bin are provided. In that case, the transformation matrix is shown by the first row and the first column in FIG. 5.

One change with respect to the ADSL standard mapping may be made in the look-up table for b=5 bits per bin. Certain rows are permuted in order to have correct coset membership. The modified look-up table is shown in below:

00

00

00

00

03

03

03

03

30

30

30

30

33

33

33

33

31

02

20

20

01

10

01

23

10

32

23

32

13

13

31

02

Bits mapped in this way will have all the properties needed for 8-way coset partitioning and mapping can be done in a generic way, with rather minimal or non-excessive overhead. The demapper at the receiver employs the inverse of the matrix T.

The following example of mapping is provided to aid in understand of the method and apparatus disclosed herein. The bits to be encoded are 1101 (decimal 13). The transform matrix in this case is

$$T = [ \begin{matrix}1 & 1 & 0 & 0 \\ 0 & 1 & 0 & 0 \\ 0 & 0 & 1 & 1 \\ 0 & 0 & 0 & 1\end{matrix} ]$$

and the mapped bits will be

$$[ \begin{matrix}1 & 1 & 0 & 1\end{matrix} ] * [ \begin{matrix}1 & 1 & 0 & 0 \\ 0 & 1 & 0 & 0 \\ 0 & 0 & 1 & 1 \\ 0 & 0 & 0 & 1\end{matrix} ] = [ \begin{matrix}1 & 0 & 0 & 1\end{matrix} ]$$

Now bits 1001 need to be mapped. In this particular example, the bits are mapped as specified in the ADSL standard, i.e. to point (−3,3)).

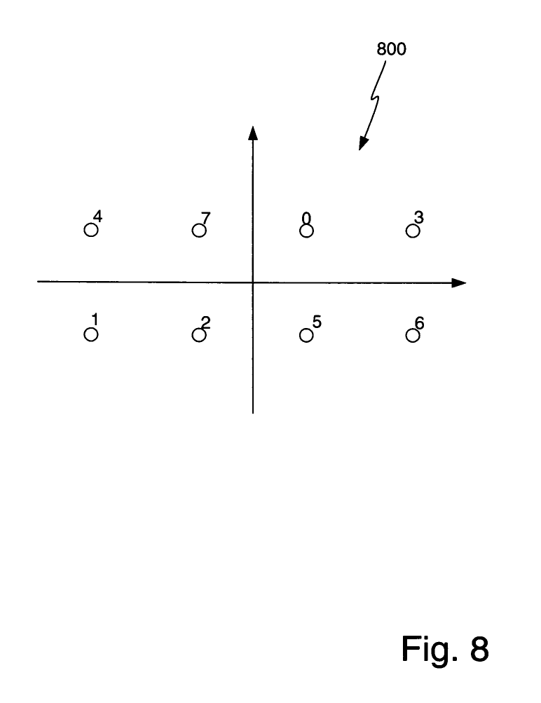

There may be, however, an exception for b=3. In particular, when there are 3 bits per bin, the above described scheme may not operate properly. As a result, the bits may be mapped as shown in the FIG. 8, which comprises an 8-point constellation 800 for b=3.

Exemplary Method Of Operation

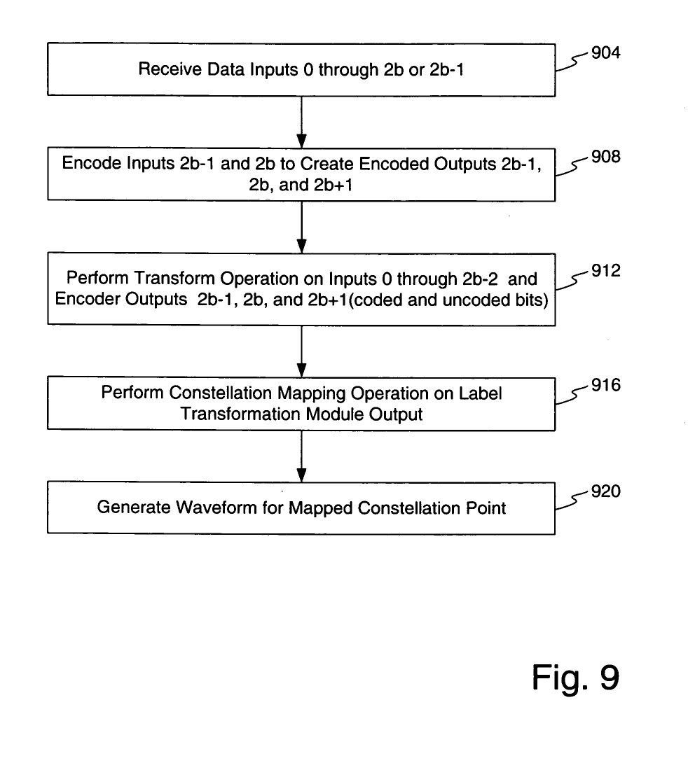

FIG. 9 illustrates an operational flow diagram of an example method of operation. This is but one example method operation and, as such, one of ordinary skill in the art may arrive at other methods of operation, after reading the detailed description in connection with the Figures, which do not depart from the scope of the invention. As shown, at a step 904, the operation receives the data inputs 0 through 2b or 2b-1 where inputs 0 through 2b or 2b-1 represent all in the inputs. It is also contemplated, however, that the encoding/transfom/mapping process may occur on less than all the inputs.

At a step 908, the operation encodes one or more of the inputs. Any number of bits may be encoded. In this example embodiment, the encoder comprises a 2/3 encoder and, as such, inputs 2b and 2b-1 are processed into outputs 2b-1, 2b and 2b+1. Thus, the two encoder input values are encoded into three outputs. Any number of inputs may be encoded into any number of outputs as would be understood by one of ordinary skill in the art.

At a step 912, the transform module receives and processes the inputs 0 through 2b+1. In this example embodiment, the process comprises matrix multiplication with the matrix shown in FIG. 5 and, as such, the inputs are transformed into a format that allows for efficient mapping within the constellation mapper. At a step 916, the output of the transform module is provided to the mapping module for mapping. In one embodiment, mapping may be performed in accordance with mapping as performed in the DSL standard. In other embodiments, the transform module may be configured to process the data into a format that is well suited for use with other mapping schemes. At a step 920, the mapped data is output from the encoding and mapping system for modulation and transmission to a remote location or for additional processing.

As an advantage over prior art systems, the use of a code other than the Wei code provides a coding gain. In some embodiments and dependant on the code and other factors, the coding gain may improve by an extra 0.8 dB. The benefit of the coding gain resulting from the use of a better code results in a higher effective data rate, a lower BER, or both. The method and apparatus disclosed herein also enjoys the benefit gained by the transform module manipulating data into a format, which may be efficiently mapped by the mapper. In some embodiments, use of a code that improves the coding gain without use of the label transformation module may result in an input to the constellation mapper which may not be efficiently mapped.

To further describe the method and apparatus claimed, exemplary simulation results are provided below in relation to one exemplary design. These simulation results are provided for discussion and as an aid to understanding one particular embodiment. The patent claims that may be made from this disclosure are not limited to these particulars or the outcome of these simulation results.

Simulation Results

In this section, simulation results are presented of testing several rate 2/3 (64, 128 and 256 state codes are given by their generator polynomials in feedback form as {115, 52, 36}, 263, 142, 164} and {401, 162, 274}, respectively) codes as well as Wei's code. Additional codes may be utilized that offer benefits over the Wei's code other than those listed. In general, a comparison should rate n/k TCM code performance on a constellation of size 2^{k} to an uncoded constellation of size 2ⁿ to preserve the rate and take constellation power increase into account. In general in this example, every bit added doubles the constellation size, i.e. increases its power by 3 dB. For smaller constellations this is only approximately true.

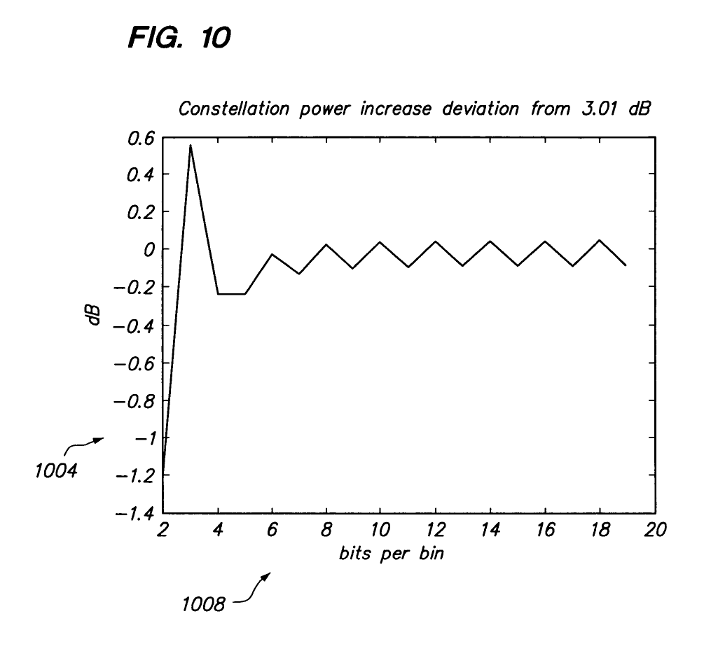

FIG. 10 illustrates bit error rate (BER) curves for uncoded and coded DMT systems with uniform bit loadings of b=2, 3 . . . 17 bits per 2D symbol. In FIG. 10, the vertical axis 1004 represents power in dB and the horizontal axis 1008 represents bits per bin. FIG. 10 illustrates the exact variation of the increase in power for each bit around the 3 dB rule (notice that odd bit constellations are square) in one example embodiment. Also, it should be pointed out that variations deviate from 3 dB significantly for b=2, 3 and 4 bits per TCM symbol. In the case of Wei's code, there is one peculiarity. It has 1 bit of redundancy per 4D symbol, which is equal to ½ bit per 2D symbol. It is not possible to find an equivalent uncoded system with integer number of bits per 2D. If done in 4D, then an odd number of bits would imply some form of shaping, which may affect the coding gain. In any case, we will assume that power penalty due to the increased constellation size is 1.5 dB. For 2D codes, we will compare coded systems to corresponding uncoded to get a fair comparison. The BER (bit error rate) curves vary as the constellation size is changed even for the same dmin, for both coded and uncoded systems. The term dmin is defined as the minimum distance between any two constellation points.

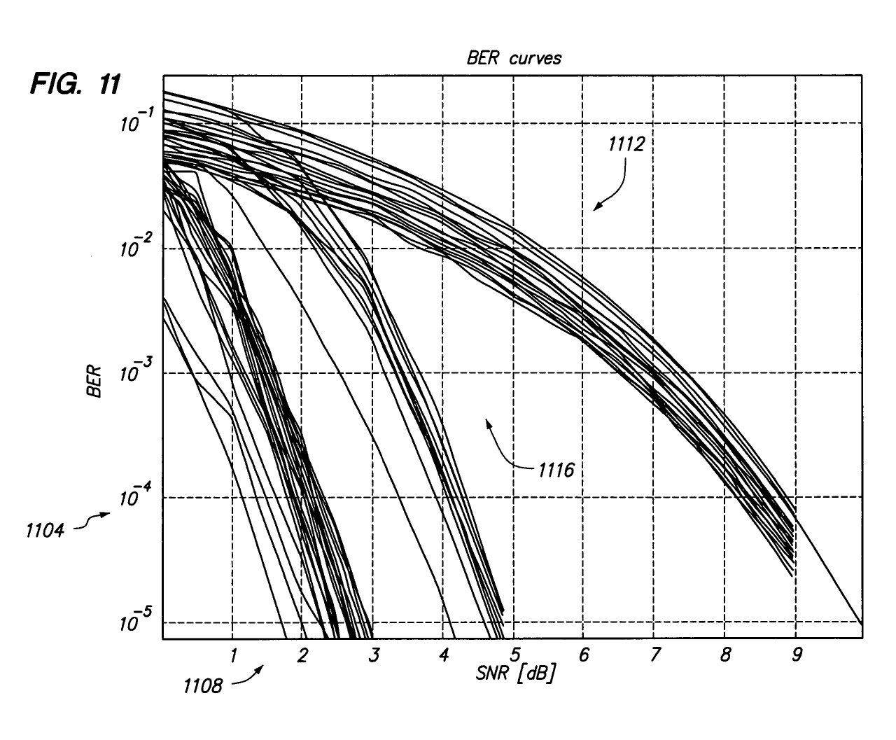

FIG. 11 illustrates plots of 2D codes for inverse functions (SNR as a function of BER) being subtracted from uncoded systems with corresponding rates. In FIG. 11, the vertical axis 1104 represents bit error rate (BER) while the horizontal axis 1108 represents signal to noise ratio, in dB. Stated another way, FIG. 11 may be considered as showing BER curves for uncoded and coded DMT systems with uniform bit loadings of b=2, 3 . . . 17 bits per 2D symbol.

The rightmost set of curves 1112 are for uncoded systems. Bits increase from 2 to 17 from right to left. All the curves converge to one single curve as BER goes to zero. Similar observation can be made for coded curves. The middle set 1116 corresponds to Wei's code. To have a fair comparison, these curves should be shifted to the right by 1.5 dB (corresponding to ½ redundancy bit per 2D symbol). Even though this code achieves 4.2 dB of coding gain for large constellations and as BER goes to zero, at BER=10⁻⁴, coding gain is about 3.5 dB. As for the 2/3 2D codes, at BER of interest to us (10⁻⁴ to 10⁻⁵), different codes have roughly the same performance, which is about 0.5-0.8 dB better than that of Wei's code.

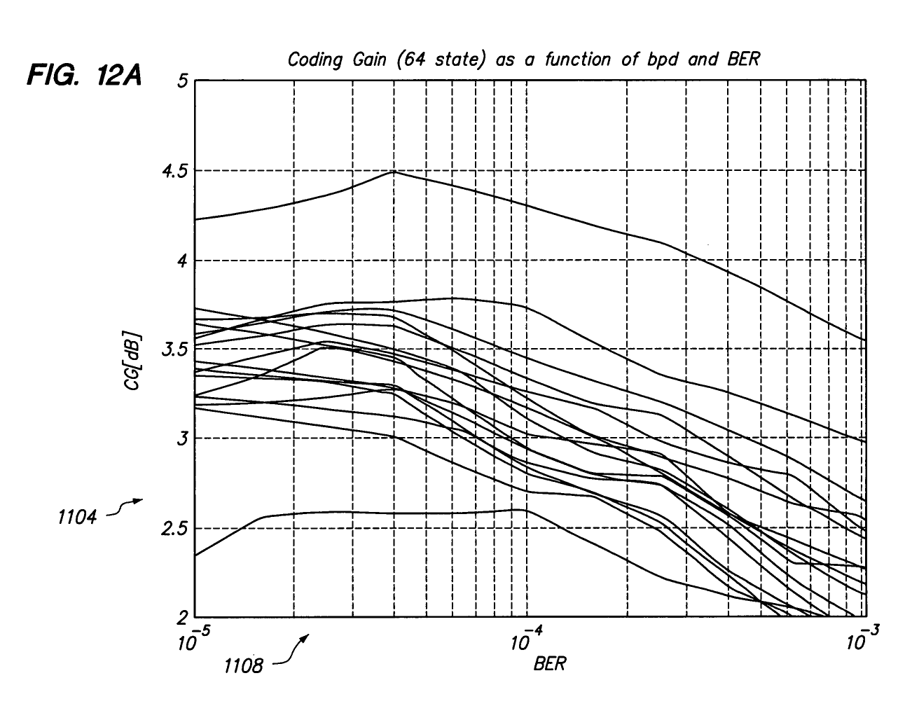

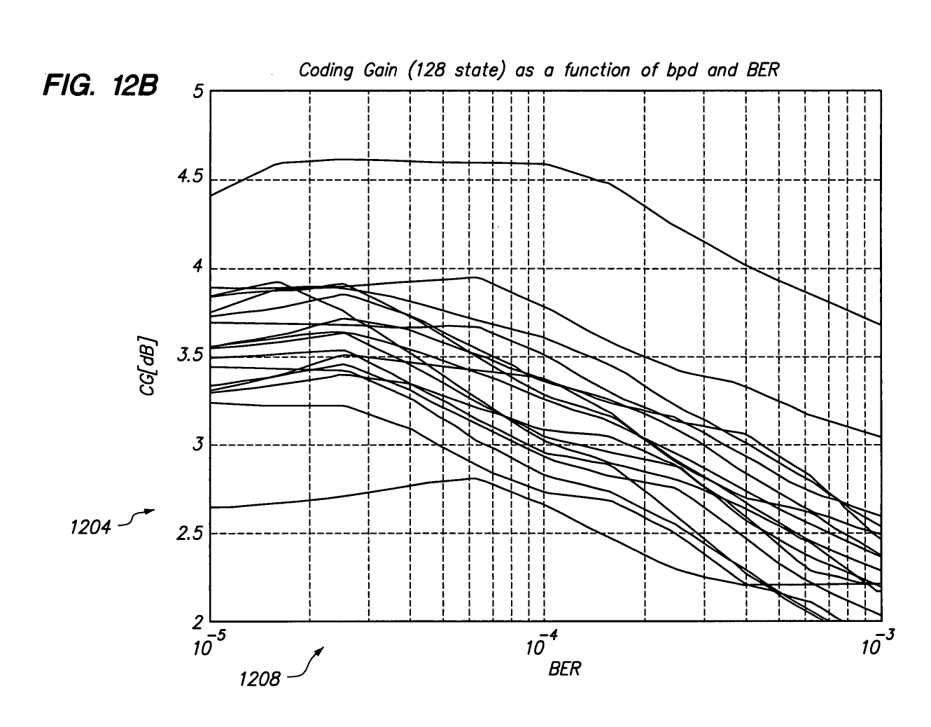

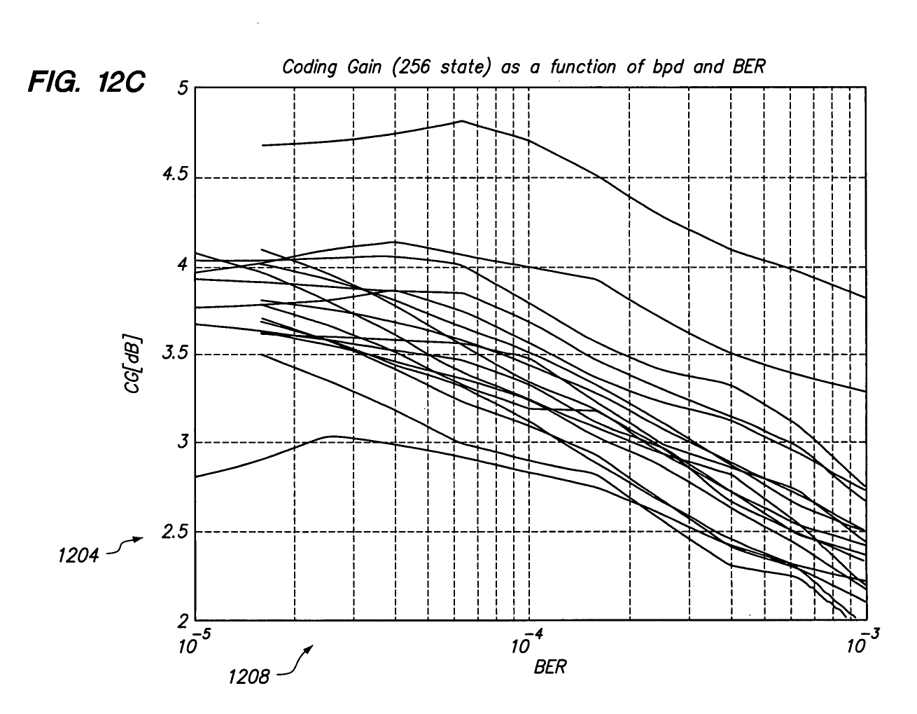

FIG. 12 illustrates the better performance of 2D codes. FIG. 12 illustrates a plot inverse functions (SNR, on the vertical axis 1204, as a function of BER, on the horizontal axis 1208). In this example embodiment, the the plots are subtracted from uncoded systems with corresponding rates. FIG. 12A illustrates a plot of a 64 state system. FIG. 12B illustrates a plot of a 128 state system. FIG. 12C illustrates a plot of a 256 state system.

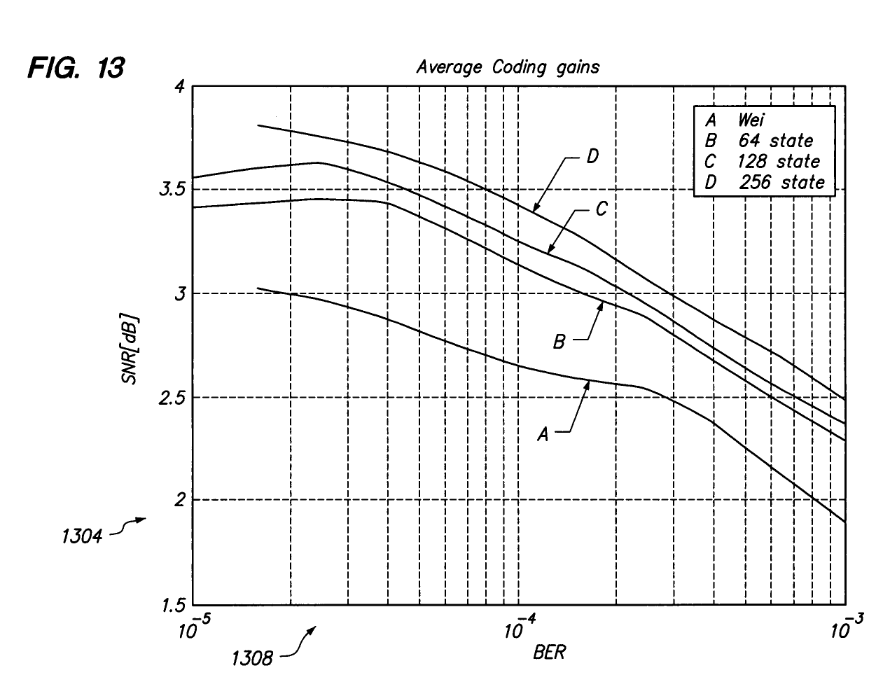

Average Coding Gain curves of the three codes are plotted in FIG. 13, where the Wie code is the bottom plot followed by plots for 64, 128, and 256 states respectively. In FIG. 13 the vertical axis 1304 represents signal to noise ratio (SNR) while the horizontal axis 1308 represents bit error rate (BER).

As can be seen in FIG. 13, there is about a 0.1 dB increase in average coding gain for each doubling in the number of states. Asymptotic coding gains increase about 0.22-0.25 dB per doubling.

Decoder Structure

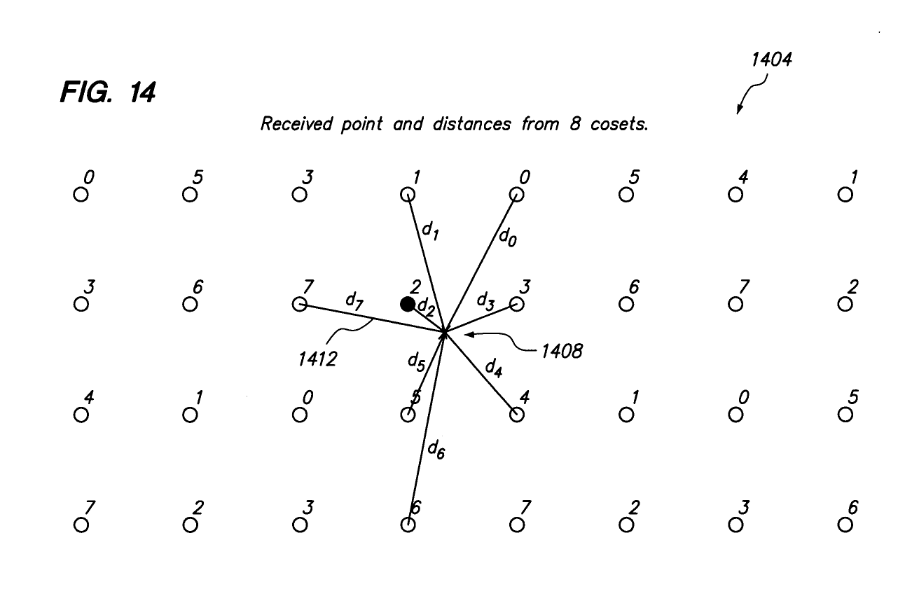

FIG. 14 illustrates a portion of a large constellation 1404 with cosets (D₀-D₇) labeled, and the received point 1408 shown as the intersection of the distance lines 1412 labeled D₀ through D₇.

In the absence of TCM, the received point 1408 would have been sliced to the black dot (labeled 2), which may not accurately occur. With TCM, the received point 1408 will be sliced to one of the 8 nearest points from each coset 1404. Which coset 1404 is chosen depends on the output of Viterbi decoder. The Viterbi process takes as input 8 distances 1412 d₀ through d₇ and updates accumulated branch metrics. After a suitable delay (corresponding to the traceback depth), it will output what it considers most probable coset 1408. Then the received point can be sliced and bits extracted. Additional discussion regarding Viterbi decoding and the demapping and decoding process may be found in the DSL standard document G.9921.1 entitled Series G: Transmission Systems and Media, Digital Systems and Media: Asymmetrical Digital Subscriber Line Transceivers, which is incorporated herein by reference in its entirety.

As an advantage over the prior art, in one embodiment, a transform operation occurs and utilizes matrix multiplication to execute the transform operation. In the case of a DMT system utilizing multiple channels or path, each sub-channel may have different number of bits. Note that in many coding schemes, coding occurs on a single channel with coding occurring across time with a fixed number of bits per baud. IN a DMT environment, the coding may occur across channels and aa fixed or variable number of bits per baud may be sent. It may be necessary to support different number of bits per constellation, which may be complex and as a result, use 4D codes may be undesirable. To overcome these issues, 2D codes may be utilized, which allows for better coding gain and less complexity.

While various embodiments of the invention have been described, it will be apparent to those of ordinary skill in the art that many more embodiments and implementations are possible that are within the scope of this invention.

1. A method for signal coding comprising:
receiving data to be coded, the data comprising inputs 0 through b, where b comprises any whole number; out of which a subset b-n_{c}+1, . . . , b will be encoded through a convolutional encoder, where n_{c} is a whole number smaller than b;
encoding the data to create encoded outputs b-n_{c}+1, . . . , b and b+1;
performing matrix multiplication on the encoded outputs with a transform matrix to achieve a transform operation to create transformed outputs; and
mapping the transformed outputs into a constellation to create a coded signal.

2. The method of claim 1, further comprising modulating the coded signal to a waveform.

3. The method of claim 1, wherein the encoding comprises a 2-dimensional code.

4. The method of claim 1, wherein encoding is performed by one or more delay elements and one or more summing junctions.

5. The method of claim 1, wherein the encoding comprises systematic encoding that converts two inputs to three outputs.

6. The method of claim 1, wherein the transform matrix comprises a matrix having main matrix diagonal of 1 values and an off diagonal comprising alternating one and zero values.

7. A system for use in a multi-channel communication system for encoding data, the system comprising:
an encoder configured to receive at least some non-encoded data on two or more inputs and encode the at least some non-encoded data to three or more outputs to create encoded data and non-encoded data;
a transform module configured to receive the encoded data and non-encoded data and modify the encoded data and non-encoded data to create transformed data; and
a mapper configured to receive the transformed data perform algorithmic mapping on the transformed data to create mapped data.

8. The system of claim 7, wherein the encoder and mapper are configured as 2-dimensional encoder and mapper.

9. The system of claim 7, wherein the encoder comprises one or more delays and one or more summing junctions.

10. The system of claim 7, wherein the system utilized a 2D code.

11. The system of claim 7, wherein the transform module comprises one or more summing junctions and one or more XOR units.

12. The system of claim 7, wherein the transform module is configured in hardware, software, or both to matrix multiply a transform matrix and the encoded data and non-encoded data to create transformed data.

13. The system of claim 7, wherein the mapper is configured to utilize one or more coset representatives and two vectors to map to any given point within a coset.

14. The system of claim 7, wherein the mapper is configured to map points using a look-up operation based on pre-determined mapping scheme.
